(19) United States
(12) Patent Application Publication
(10) Pub. No.: US 2015/0216105 A1
(43) Pub. Date: Aug. 6, 2015

(54) FLEX ROLLER-CRIMPER FOR IMPROVED MANAGEMENT AND TERMINATION OF COVER CROPS AND OTHER PLANT MATERIAL

(71) Applicant: UNIVERSITY OF TENNESSEE RESEARCH FOUNDATION, Memphis, TN (US)

(72) Inventor: Shawn Butler, Jackson, TN (US)

(73) Assignee: UNIVERSITY OF TENNESSEE RESEARCH FOUNDATION, Memphis, TN (US)

(21) Appl. No.: 14/614,827

(22) Filed: Feb. 5, 2015

Related U.S. Application Data
(60) Provisional application No. 61/936,058, filed on Feb. 5, 2014.

(51) Int. Cl. A01B 61/04; A01B 39/08

(52) U.S. Cl. CPC A01B 61/046; A01B 39/08

(57) ABSTRACT

Herein is described an agricultural device that can include a frame; and a plurality of roller-crimping devices supported by the frame arranged in at least one row oriented in a direction that is transverse to a direction of travel of the agricultural device. Each of the plurality of roller-crimping devices having an exterior surface configured to at least partially crush stems of residual plant matter, and being individually movably mounted to the frame such that each of the plurality of roller-crimping devices will move at least vertically with respect to the frame when subjected to a temporary increase in resistance caused by an encounter with a non-uniform region in the field.

### CROSS-REFERENCE TO RELATED APPLICATIONS

This disclosure claims the benefit of priority to U.S. Provisional Patent Application No. 61/936,058 filed Feb. 5, 2014, which is incorporated herein in its entirety.

### TECHNICAL FIELD

This invention relates to agricultural devices, more directly relating to field preparation for planting or sowing cash crops in no-tillage cropping systems where cover crops, undesirable plants, or plant residue exist by means of an improved modular apparatus for roller-crimping.

### BACKGROUND OF THE INVENTION

Since the development of “no-till” farming, researchers, consultants, and growers have adopted the practice for its economic and environmental benefits. “No-till” practices consist of managing cash crops with minimal to no tillage used, and inversely relies on herbicides to manage undesirable plants. No-till farming offers many positives, such as reducing erosion, water runoff, as well as fuel, time, and labor costs. However, no-till still possesses issues. Since the fields are not tilled, soils become compacted, which severely reduces the ability of water to filter through the soil. In turn, soil compaction reduces crop yield. In areas in which soil compaction occurs and there are limited amounts of plant residue on the soil surface, water runoff occurs. Water runoff not only results in unused water, it also moves residual pesticides away from the targeted area and also causes soil erosion. Also, due to the heavy reliance on herbicides to manage undesirable plants, some of these plants have acquired herbicide tolerances, making them both challenging and costly to manage.

In order to combat issues caused by no-till farming, the use of cover crops is gaining popularity. Cover crops are simply plants grown in an area for economic and environmental benefits in the time in which the cash crop is not being cultivated. Cover crops typically are grass, legume, or brassica species. Cover crops help to minimize erosion by introducing large amounts of plant residue on the soil surface. Cover crops also help to reduce soil compaction by making the soil more penetrable with their root systems. Cover crops help to suppress weeds by competing for water, sunlight, and soil nutrients. Cover crops also add soil organic matter, creating a more fertile growing medium for cash crops. Additionally, some cover crops, such as many legume species, fixate nitrogen in the soil through a symbiotic relationship with Rhizobium bacteria on their root systems that convert nitrogen gas from air in the soil into ammonium that can be used by the cash crop. Cover crops such as wheat, rye, barley, and oats also give a grower the option to harvest for grain if they desire.

Although cover crops offer many attractive benefits, inefficient methods of termination are slowing their adoption rate. Typically, cover crops are terminated by means of chemical herbicides. However, in some scenarios, such as organic farming, herbicides may not be an option. Alternately, cover crops and undesirable plants can also be terminated by means of a roller-crimper.

Currently, a roller-crimper is an elongated, hollow cylinder with fixed blades evenly spaced around the cylinder in a chevron or helical arrangement. It is used to roll over and press cover crops or plant material and evenly crimp or pinch the stems of the plants, preventing translocation of water and nutrients, resulting in termination of the plant. Current roller-crimpers range from 5 feet in length to 15 feet in length, but can be custom built up to 40 feet in length. A roller-crimper is typically attached to the three-point hitch on the front or rear of a tractor or attached to a drawbar and pulled behind a tractor. Roller-crimpers ranging from 5 feet to 15 feet in length can be attached to the front of the tractor, rolling and crimping cover crops during planting. However, current commercial roller-crimpers over 15 feet in length require an individual pass to be made to roll and crimp the cover crop before the planter is able to sow seed of the desired cash crop. Growers then unhook the implement from the tractor and load the roller-crimper on a separate trailer for transportation.

A roller-crimper crushes and terminates cover crops or plant material and evenly crimps the stems of the plants, preventing translocation of water and nutrients. However, current roller-crimpers are not effective on uneven surfaces and slopes, because the roller-crimper is unable to make uniform contact with the cover crop unless the surface is perfectly flat. Also, current roller-crimpers do not allow a grower to leave living cover crops or plant biomass in between the planted rows of the cash crop.

As interest in the use of cover crops continues to increase, a crucial part of a cover crop system is how to terminate the cover crop prior to or during planting. Also, there is a need for an improved method of creating a better surface when planting into or managing in-season existing undesirable plants or harvest residue in double-crop systems. A flex roller-crimper has been designed for three purposes: terminating living cover crops broadcast or in strips, roller crimping existing undesirable plants broadcast or in strips, or roller crimping harvest residue broadcast or in strips in double-crop systems.

### SUMMARY OF THE INVENTION

A flex roller-crimper is disclosed. The flex roller-crimper is comprised of a modular system of cylindrical drum units mounted to a frame by parallel linkage and an adjustable tension or biasing mechanism. The flex roller-crimper system consists of two types of drum units, a strip unit and a row middle unit. Each individual drum unit is attached to the frame separately, having the capability of being individually movably mounted to the frame, pivoting up and down perpendicular to the ground based upon topography of the surface in which it contacts, or to be lifted in a storage position in instances in which it is not being used. The strip unit terminates and manipulates cover crop, plant material, or harvest residue within the area of which the cash crop will be planted in a row without disturbing the soil surface. The strip unit consists of but is not limited to about a 6 to 8 inch diameter cylinder, with 2 to 4 inch blades in height, spaced 2 to 4 inches around the cylinder in a discontinuous chevron pattern and is about 10 to 12 inches wide. The row middle units terminate and manipulate cover crop, plant material, or harvest residue within the area that would fall in between rows of planted desired cash crops without disturbing the soil surface. The row middle unit consists of but is not limited to about a 6 to 8 inch diameter cylinder, with about 2 to 4 inch blades in height, spaced about 2 to 4 inches around the cylinder in a chevron pattern and is about 10 to 30 inches wide.

The flex roller-crimper system can be attached to a frame in multiple ways including strip units alone, row middle units alone, or both strip units and row middle units. One embodiment utilizes strips units attached to a frame alone to terminate and manipulate cover crop, plant material, and harvest residue within the area of which the cash crop will be planted in a row prior to planting a cash crop or during the act of seeding the cash crop without disturbing or tilling the soil surface.

Another embodiment utilizes the row middle units attached to a frame alone to terminate and manipulate cover crop, plant material, and harvest residue within the area located in between rows of planted desired cash crops after crops have emerged from the soil without disturbing or tilling the soil surface.

Another embodiment utilizes both the strip and row middle units attached to a frame with the purpose of broadcast terminating or manipulating cover crops, plant material, and harvest residue prior to planting a cash crop or during the act of planting a cash crop without disturbing or tilling the soil surface over the entire swath of the implement. In this embodiment, both the strip and row middle units, the drum units are arranged in dual rows comprised of a first row and a second row. The first row of drum units of the dual row is located in front of the second row of drum units in an offset configuration. Drum units are attached to the frame and located alternately between each row so that each adjacent drum unit is located in a different row than its adjacent neighbor drum unit. One of the dual rows is comprised of the strip roller-crimper drum units that roll and crimp the area to be planted known as the planted row. The strip unit, when attached to a planter, is oriented in front of each individual planter row unit. The other row of the dual rows is comprised of the row middle roller-crimper drum units that roll and crimp the row middle. The row middle unit when attached to a planter is oriented in between each individual planter row unit.

The frames to which the flex roller crimper system can be attached consist of but are not limited to planters to terminate and manipulate cover crop, plant material, or harvest residue simultaneously while planting the cash crop, or attached to a toolbar as a stand-alone system, terminating and manipulating cover crop, plant material, or harvest residue prior to planting the cash crop or after the cash crop has emerged. The flex roller-crimper drum units may be attached to the frame by a parallel linkage designed specifically for each individual application. A parallel linkage, which is understood by those within the art, consists of a bracing that connects to the bearings of each individual drum and each individual perspective point on the frame for that drum unit. Parallel linkage also consists of a biasing device that includes but is not limited to spring, pneumatic, or hydraulic tensioners to meter down pressure, allowing flexibility and to lift drum units when not in use.

### DESCRIPTION OF THE DRAWINGS

FIG. 1 is a front view perspective of an embodiment of a dual row flex roller-crimper attached to a planter as disclosed in the current application.

FIG. 2 is a top view perspective of a modular roller drum unit.

FIG. 3 is a side view perspective of a modular roller drum unit.

FIG. 4 is a front view perspective of an embodiment of a dual row flex roller-crimper attached to a planter frame as disclosed in the current application.

FIG. 5 is a top view perspective of an embodiment of a dual row flex roller-crimper as disclosed in the current application.

### DETAILED DESCRIPTION OF THE INVENTION

It should be understood that the present disclosure is to be considered as an exemplification of the present invention, and is not intended to limit the invention to the specific embodiments illustrated. It should be further understood that the title of this section of this application (“Detailed Description of the Invention”) relates to a requirement of the United States Patent Office, and should not be found to limit the subject matter disclosed herein. References made to certain directions such as “front” and “rear: are made as viewed from the side of the flex roller-crimper.

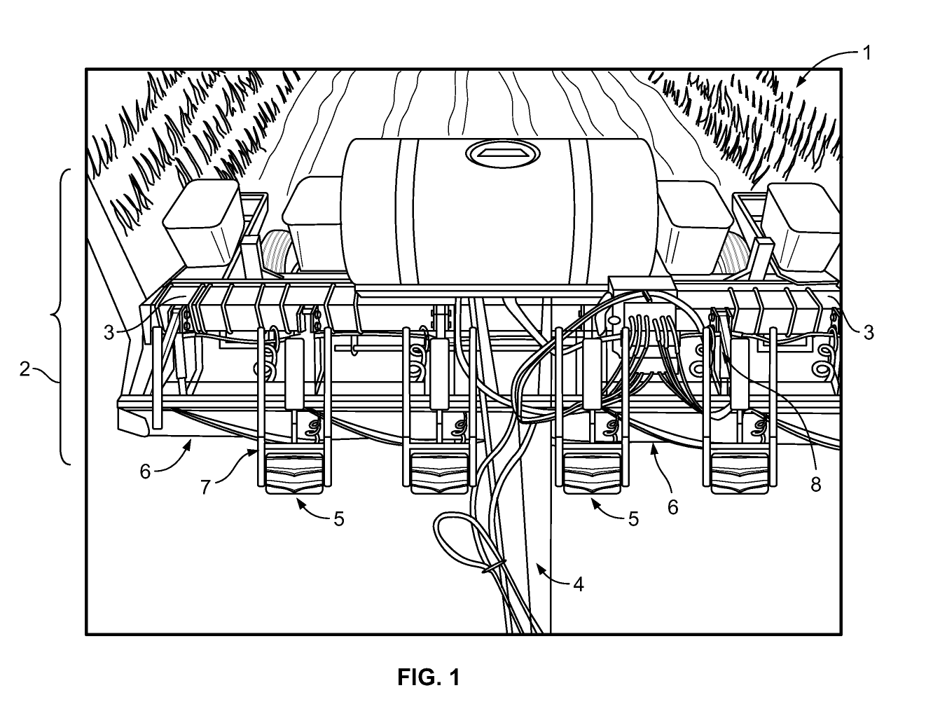

FIG. 1 shows an embodiment of an agricultural device 2 according to the present disclosure in a field 1. The agricultural device 2 includes a frame/toolbar 3. A plurality of drum units (5,6) is attached to the frame/toolbar of the agricultural device 2. Each strip drum unit 5 is attached to the frame/toolbar 3 by a strip drum parallel linkage 7 providing the capability of being individually movably mounted to the frame, pivoting up and down perpendicular to the ground based upon topography of the surface in which it contacts, or to be lifted in a storage position in instances in which it is not being used. Also, row middle drum units 6 are attached to the frame/toolbar 3. Each row middle drum unit 6 is attached to the frame/toolbar 3 by the row middle parallel linkages 8 providing the capability of being individually movably mounted to the frame, pivoting up and down perpendicular to the ground based upon topography of the surface in which it contacts, or to be lifted in a storage position in instances in which it is not being used.

As further shown, frame/toolbar 3 includes components associated with a conventional planter. However, the frame/toolbar 3 is not limited to a planter, and may be incorporated into a different agricultural implement or device.

As shown, agricultural device 2 includes a tongue or draw bar 4 that is towed by a vehicle such as a tractor (not shown). In one embodiment, the agricultural device may be operatively connected, i.e., towed by or otherwise secured to a vehicle, such as a tractor or apparatus generally or specifically configured for use with the agricultural device, and may be used with another implement or application, or used without another implement. In other words, the agricultural device may be operatively connected to either an implement or to a vehicle, although the agricultural device may be used by itself or in combination with another implement. It is to be understood while other machines or apparatus may also be operatively connected to the agricultural device or to a vehicle, such as a tractor or apparatus generally or specifically configured for use with the agricultural device, the other machines or apparatus may or may not be used in combination with the agricultural device.

The frame/toolbar 3 may be about 12 feet in width by about 8 feet in depth to roller-crimp about a 10-foot swath. The modular drum units can be oriented across the width of any toolbar based on desired swatch coverage. The strip drum units 5 located in the front half of the agricultural device 2 may be about 6-8 inches in diameter to about 10-12 inches in width. The row middle drum units 6 located in the rear half of the agricultural device 2 of FIG. 1 are about 20 to 28 inches in width, varying based upon total swath width of the entire implement. Each drum unit is attached by parallel linkages understood by those in the art. Downward pressure is regulated by means of air, hydraulic, spring tensioners, or any other biasing device that is known by those in the art. The agricultural device 2 is attached to a tractor or a vehicle to be pulled through the field. It is connected by means of a draw bar, tongue or three-point hitch 4.

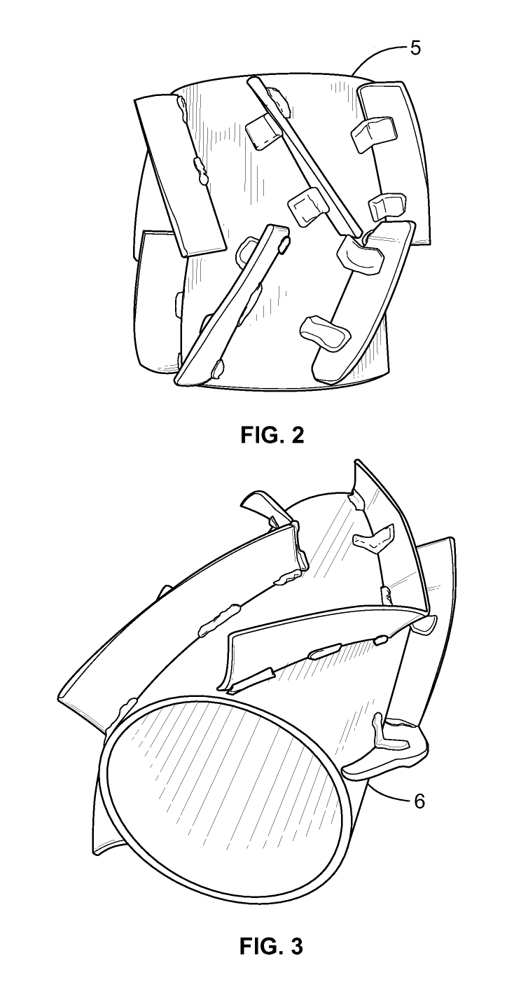

FIG. 2 illustrates an embodiment of a modular roller drum as disclosed in this invention. The illustrated embodiment depicts blades attached to the drum unit in a discontinuous chevron pattern. The modular drum unit can be oriented across the width of any toolbar based on desired swatch coverage. This embodiment of a modular drum unit may be used as strip drum units 5, which are usually located in the front row of drum units of the flex roller-crimper, but may also be located in the rear row of drum units and may be about 6-8 inches in diameter to about 10-12 inches in width. Another embodiment may be used as row middle drum units 6 usually located in the rear row of drum units of the agricultural device 2 of FIG. 1 but may be located in the front row and are about 20 to 28 inches in width, varying based upon total swath width of the entire implement.

FIG. 3 illustrates another embodiment of a modular roller drum. The illustrated embodiment depicts blades attached to the drum unit in a chevron pattern. The modular drum unit can be oriented across the width of any toolbar based on desired swatch coverage. This embodiment of a modular drum unit may be used as strip drum units 5 usually located in the front row of drum units of the flex roller-crimper, but may also be located in the rear row of drum units and may be about 6-8 inches in diameter to about 10-12 inches in width. This embodiment may be used as row middle drum units 6 that usually are located in the rear row of drum units of the agricultural device 2 of FIG. 1 but may be located in the front row and are about 20 to 28 inches in width, varying based upon total swath width of the entire implement.

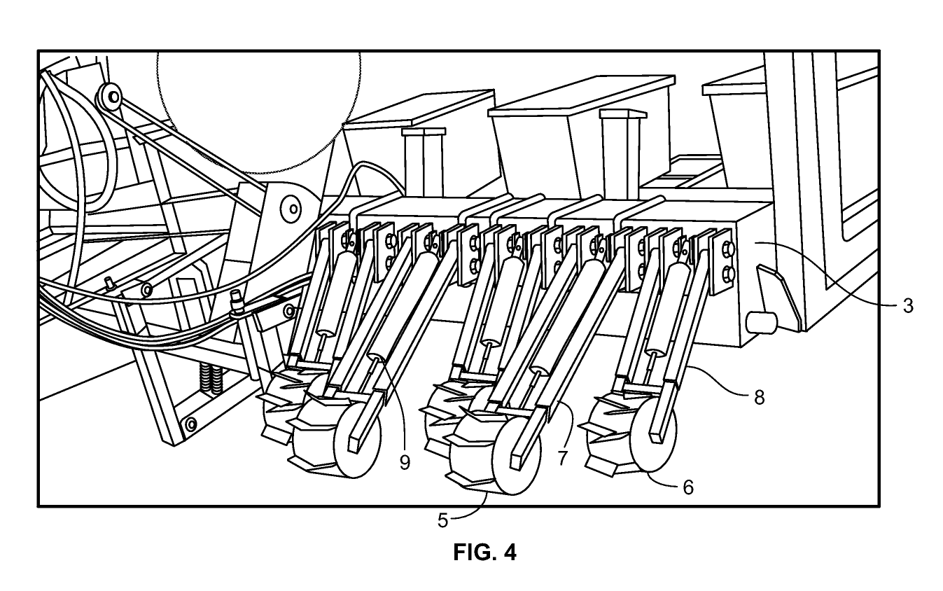

FIG. 4 illustrates that the roller-crimper drum units 5,6 are offset so that the strip drum units 5 are rolling and crimping the planting furrow area without disturbing or tilling the soil and the row middle drum units 6 roll and crimp the area between the planting strips. The strip drum units 5 are attached to the frame by parallel linkages 7 or an equivalent means to both raise and lower each individual drum unit 5. As understood by a person of ordinary skill in the art, the means by which the strip drum units may be lifted include pneumatically, hydraulically, fixed, or free floating. For example, biasing device, such as a tensioner 9, may act as the attachment between the frame and the strip drum unit. The tensioner 9 would force downward pressure but allow for upward movement of the drum unit. Downward pressure is regulated by means of air, hydraulic, spring tensioners, or any other that is known by those in the art. This allows for constant contact with the ground and the drum unit. Other suitable means are within the scope of this disclosure. The row middle drum units are attached to the frame by parallel linkages 8 or an equivalent means as known to those skilled in the art. As understood by a person of ordinary skill in the art, the means by which the row middle drum units may be lifted include pneumatically, hydraulically, fixed, or free floating. A biasing device, such as a tensioner 9, may act as the attachment between the frame and the strip drum unit. The tensioner 9 would force downward pressure but allow for upward movement of the drum unit. Downward pressure is regulated by means of air, hydraulic, spring tensioners, or any other biasing device that is known by those in the art. This allows for constant contact with the ground and the drum unit. Other suitable means are within the scope of this disclosure.

One embodiment of the disclosure would entail an about 30″ spacing configuration wherein the strip drum units 5 are about 10″ wide and the row middle drum units 6 are about 22″ wide. Tone embodiment of this disclosure would entail an about 2″ overlap between neighboring strip drum units 5 and row drum units 6. Other spacing configurations with different widths are within the principles of the disclosed flex roller-crimper. The flex roller-crimper may be attached to a frame 3 that would be connected to a tractor or a vehicle to be pulled through the field. It is connected by means of a tongue 4, draw bar, three-point hitch, or any other suitable means. In an instance that the implement is pulled by a drawbar, wheels will be fixated on the tool bar with hydraulic lift cylinders for transportation.

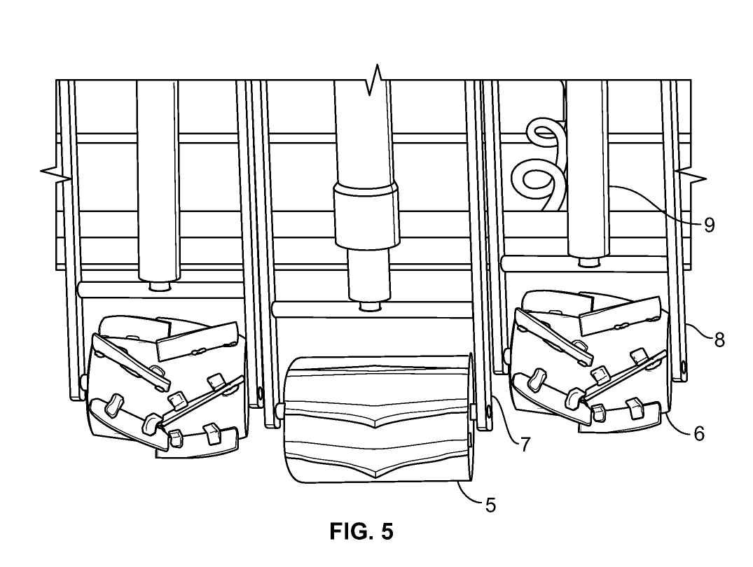

FIG. 5 illustrates the alternating alignment of the strip roller-crimper drum units 5 and the row middle roller-crimper drum units 6 as attached to a frame 3. The strip drum unit 5 is to be oriented offset and to the front of the row middle unit 6 to allow for spacing for the parallel linkage 7 to attach each drum unit to a frame 3. Biasing device 9, as understood by those skilled in the art, regulates downward pressure to insure adequate rolling with varying terrain while allowing for upward movement of the drum unit. The biasing device may be may be an air, hydraulic, or spring tensioner, or any other biasing device that is known by in the art. This allows for constant contact with the ground and the drum unit. Other suitable means are within the scope of this disclosure.

In one embodiment of the flex roller-crimper, the flex roller-crimper comprises a system of substantially cylindrical drum units with or without fixed blades spaced around the cylindrical drum units. The strip drum units are about 10-12″ wide and attached to a frame. The strip drum units roll and crimp cover crop, plant material, or harvest residue in the area in which the cash crop will be planted. The row middle drum units may be about 12″ wide for about a 20″ planting row, about 22″ wide for about a 30″ planting row, or about 30″ wide for about a 38″ planting row. The row middle drum units are also attached to the frame and are usually offset to the rear of the strip drum units. The drum units nearly uniformly make contact with the ground the entire span of the frame. Alternatively, the row middle roller-crimper units can be lifted between the rows, leaving living cover crop, decomposing prior terminated cover crop, or harvest residue untouched between the planted rows.

Any planting row size can be accommodated by adjusting the size of the drum units and the aforementioned planting row spacing is not meant to be limiting rather the examples are only meant to be exemplifications of the disclosed flex roller-crimper.

The frame may be a toolbar or other suitable field transport system. The flex roller-crimper can be attached to a planter or tractor by suitable means such as a category II or III, narrow or wide bolt on with or without adjustable links, a T-shaped mounting bracket on the frame. The point of attachment may also be a customized control arm or a pneumatic, hydraulic, spring, or fixed tensioner. Other suitable means for attachment are within the scope of this disclosure.

A second embodiment comprises the strip drum units in the front and the row middle drum units being offset behind the strip units.

A third embodiment comprises the flex roller-crimper attached to a frame attached to a planter, the roller-crimper drum units are offset, allowing room for mounting each individual drum while still stretching the entire span of the planter and creating some overlap in the ground coverage of the adjacent drum units, so that the strip drum units are rolling and crimping the planting strip in front of the row middle drum units, which roll and crimp the row middles between the planting units. Each drum unit is attached to the frame of the planter unit by means to both raise and lower each individual drum unit. As understood by a person of ordinary skill in the art, the means by which the drum units may be lifted include pneumatically, hydraulically, fixed, or free floating. Other suitable means are within the scope of this disclosure. It is further understood that any blade pattern or design known in the art may be utilized with the drum unit, including a smooth drum unit design. The drum units are attached to the frame of the planter by suitable means. Examples of means that are well known to those of skill in the art include a parallel adjustable control arm. Other suitable means are within the scope of this disclosure.

A fourth embodiment comprises the flex roller crimper wherein the flex roller-crimper comprises a system of drum units with or without fixed blades. The strip drum units are substantially cylindrical and about 6-8″ wide and attached to the frame. The strip drum units roll and crimp cover crop, plant material, or harvest residue in the area in which the cash crop is to be planted. Alternatively, the strip drum units may be lifted so that the row middle drum unit may be used to terminate plant material between the planted rows or rows being prepared for planting.

The row middle drum units are substantially cylindrical and may be about 12″ wide for about a 20″ planting row, about 22″ wide for about a 30″ planting row, or about 30″ wide for about a 38″ planting row. The row middle drum units are also attached to the frame and are offset to the rear of the strip drum units. The drum units nearly uniformly make contact with the ground over the entire span of the frame. Alternatively, the row middle roller-crimper units can be lifted between the rows, leaving living cover crop, decomposing prior terminated cover crop, or harvest residue untouched between the planted rows.

The foregoing description and the examples are intended as illustrative and are not to be taken as limiting. Still other variations within the spirit and scope of this invention are possible and will readily present themselves to those skilled in the art.

1. An agricultural device comprising:
a frame; and
a plurality of roller-crimping devices supported by the frame arranged in at least one row oriented in a direction that is transverse to a direction of travel of the agricultural device,
each of the plurality of roller-crimping devices having an exterior surface configured to at least partially crush stems of residual plant matter, and being individually movably mounted to the frame such that each of the plurality of roller-crimping devices will move at least vertically with respect to the frame when subjected to a temporary increase in resistance caused by an encounter with a non-uniform region in the field.

2. The agricultural device of claim 1, wherein the agricultural device is free of tilling mechanisms.

3. The agricultural device of claim 1, wherein each of the plurality of roller-crimping devices comprises a cylindrical drum.

4. The agricultural device of claim 3, wherein each of the plurality of roller-crimping devices further comprises plurality of outwardly projecting blades.

5. The agricultural device of claim 4, wherein each of the plurality of blades are arranged evenly about the cylindrical drum.

6. The agricultural device of claim 4, wherein the plurality of blades are arranged about the cylindrical drum in a helical pattern.

7. The agricultural device of claim 1, wherein the plurality of roller-crimping devices include at least one row middle unit.

8. The agricultural device of claim 1, wherein the plurality of roller-crimping devices include at least one strip unit.

9. The agricultural device of claim 8, wherein the plurality of roller-crimping devices include at least two row middle units.

10. The agricultural device of claim 9, wherein the at least one strip unit is flanked on opposite sides by a respective one of the at least two row middle units.

11. The agricultural device of claim 9, wherein the at least one strip unit is positioned on the frame to operate on plants located in a row.

12. The agricultural device of claim 9, wherein the at least two row middle units are positioned on the frame to operate on plants located between rows.

13. The agricultural device of claim 9, wherein each of the at least one strip unit and the at least two row middle units are attached to the frame and located alternately in rows so that adjacent ones of the plurality of roller-crimping devices are located in a different row.

14. The agricultural device of claim 13, wherein the at least two row middle units are located in a different row than the at least one strip unit.

15. The agricultural device of claim 13, wherein each of the plurality of roller-crimping devices are attached to the frame by a parallel linkage.

16. The agricultural device of claim 13, further comprising a biasing device attached to the linkage that generates at least a downward pressure on an attached one of the plurality of roller-crimping devices.

17. The agricultural device of claim 16, wherein the biasing device is a coil spring.

18. The agricultural device of claim 17, wherein the biasing device is one of a pneumatically controlled actuator and a hydraulically controlled actuator.
